(19) United States
(12) Patent Application Publication
(10) Pub. No.: US 2005/0057745 A1
(43) Pub. Date: Mar. 17, 2005

(54) Measurement methods and apparatus

(76) Inventor: Douglas A. Bontje, Sedalia, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 10/940,368

(22) Filed: Sep. 14, 2004

Related U.S. Application Data
(60) Provisional application No. 60/504,482, filed on Sep. 17, 2003.
(60) Provisional application No. 60/569,842, filed on May 11, 2004.

(51) Int. Cl. G01C 1/00; G01B 11/26

(52) U.S. Cl. 356/139.03

(57) ABSTRACT

A measurement device is provided that allows for determining distance, range and bearing of a target of interest. The distance, range and bearing to the target of interest are determined relative to the position of the measurement device and are stored in memory. The device is further operative to translate these relative positions of the target to an absolute position at the time of measurement, or, when the position of the measurement device becomes known. The absolute position of the measurement device may be determined utilizing GPS technologies or through the measurement of geophysical reference points. Measurement of the relative location of target(s) of interest is performed utilizing an electronic range finding device and elevation and heading sensors. The resulting information is stored in memory for conversions to vector information that may be utilized to generate, for instance, topographical images.

### CROSS-REFERENCE TO RELATED APPLICATIONS

This application claims priority under 35 U.S.C. § 119 to U.S. patent application Ser. No. 60/504,482 entitled “Measuring Methods and Apparatus,” filed on Sep. 17, 2003, and further claims priority under 35 U.S.C. §119 to U.S. patent application Ser. No. 60/569,842 entitled “Measurement Methods and Apparatus,” having a filing date of May 11, 2004. The entire disclosures of U.S. patent application Ser. No. 60/504,482 and U.S. patent application Ser. No. 60/569,842 are incorporated herein by reference as if set forth in full.

### FIELD OF THE INVENTION

The present invention relates in general to surveying. More specifically, the present invention relates to methods and apparatus that allow for reducing labor and training required to provide precise three-dimensional measurement data and images of land and land related surfaces and spaces. The invention functions as a field instrument that can tie measured data to other types of information such as GIS data, aerial images, parcel maps, and architectural plans. It can also guide a user though the difficult process of determining the physical location of stakes and marks used for construction.

### BACKGROUND

Surveying has historically been a labor intensive process and required considerable training to allow a surveyor to precisely locate geophysical locations and/or translate design plans to geophysical layouts. Typically, surveying has required a first person to operate a survey instrument (e.g., theodolite) and a second person to hold a marker pole/target on a desired landmark. In this regard, the first person may “sight” the second person and take relative angular readings (e.g., azimuth and elevation readings) from the survey instrument to determine the position of the landmark relative to the survey instrument. Further, a distance between the survey instrument and the landmark must be measured. As will be appreciated, by utilizing the relative angles and distance, the relative location of the landmark to the survey instrument may be determined. Furthermore, the absolute or geodetic position of the landmark may be determined if the absolute position of the survey instrument in known.

The instrument most typically used for surveying is a theodolite. Such instruments typically include a sight, an azimuth gauge (e.g., compass) and a tilt or inclinometer for ascertaining the direction and angle of inclination between the theodolite and a landmark. All theodolites have similar constructional features regardless of their age or level of technology and all perform basically the same function: measuring angles in horizontal and vertical planes. Typically, theodolites are designed to be mounted on a tripod to allow their installation on a vertical axis directly above a reference point (e.g., a geodetic point). In this regard, time must be spent aligning the survey instruments with the vertical axis and may entail adjusting the legs of a tripod and/or adjusting a leveling plate associated with the survey instrument.

To facilitate the surveying process, many modern theodolites incorporate one or more electronic features. For instance, many modern theodolites electronically provide azimuth and elevation information and/or incorporate electromagnetic distance meters for providing distance information between the device and a sighted landmark. These modern survey instruments also typically have onboard microprocessors and are operable to interface with data recording devices and/or computers. Such survey instruments are known under a variety of names, including electronic tachometers and total stations.

Sighting systems for survey instruments have typically incorporated a scope for use in identifying a desired landmark and/or positioning a target at a desired position on the landmark. However, some modern survey devices have incorporated laser markers that are operative to project a laser mark onto a landmark. Utilization of such a laser marker may allow a single user to project the laser mark onto a desired position on the landmark for measurement purposes and thereby eliminate the need of a second individual.

Electromagnetic distance meters utilized with modern survey instruments include laser range finders that determine distance by reflecting light of a target positioned at a landmark and/or from light reflected from the landmark itself. Such electromagnet measuring devices may eliminate the need for the surveyor to physically measure the distance between a surveying device and a landmark.

In order to determine the position of the survey instrument and/or relative positions of landmarks to the instrument, it has historically been necessary to take readings from three or more different locations. In an attempt to alleviate this shortcoming, some modern survey instruments have incorporated GPS systems which can provide a known location for the survey instrument. This may allow for the determination of the geodetic coordinates (i.e., actual location) of the measurement instrument and possibly eliminate the need for direct measurement of known geophysical reference points. To increase the accuracy of these GPS equipped instruments to a level satisfactory for surveying purposes, advanced GPS systems have been utilized. These advanced GPS systems include differential GPS (DGPS) and real-time kinetic (RTK) GPS.

While incorporation of electromagnetic distance meters, GPS systems and/or laser markers into surveying instruments has reduced the labor required for gathering survey information, such systems have various limitations. For instance, GPS systems are only operable where the systems have unobstructed view of at least three or four GPS satellites. That is, such instruments do not bridge the gap between indoor and outdoor areas. Furthermore, such systems cannot currently provide means by which modeled data (e.g., design plans) may be tied to a survey area such that points within the modeled data may be readily located relative to the surveyed area.

### SUMMARY OF THE INVENTION

Disclosed herein is a measurement instrument that allows for determining distance, range and bearing of a target of interest. Specifically, distance range and bearing to the target of interest are determined relative to the position of the measurement device and are stored in memory. The device is further operative to translate these relative positions of the target to an absolute position. In this regard, if the absolute position of the device is known prior to determining the distance range and bearing of a target, the absolute location of that target may be determined during measurement. Alternatively, if the absolute location of the measurement device is not known prior to measurement, the relative position of the target to the measurement device may be stored for later conversion. In this regard, the absolute position of the measurement device may be determined utilizing GPS technologies that may be incorporated into the device or through the measurement of geophysical reference points. In any case, once the absolute position of the device is known, the relative position of the target may converted into an absolute position. Though discussed primarily in relation to its use for surveying, it will be appreciated that the measurement choice may be utilized for different purposes. The measurement device may also be utilized in any application where it may be desirable to determine the relative position of one or more objects to a point of reference. A non-inclusive list of possible applications includes: crime scene measurements, accident investigation, archeological site mapping and mining

To facilitate distance measurements, the device utilizes an electronic range finding device. In one embodiment, the electronic range finding device comprises a laser that may be controllably pulsed. Accordingly, the device further incorporates a receiver for receiving reflected light associated with the laser pulses in order to determine flight time and hence the distance of a targeted object from the device. Finally, the device includes a sensor operative to determine the angular orientation of the electronic range finding device. This allows determining the relative angular position of a target of interest as the measurement device. This sensor may include an inclinometer and heading device for use in determining, for example, the relative elevation and azimuth a target relative to the measurement instrument.

According to a first aspect of the present invention, the device utilizes an electronic range finder to calculate vectors between a reference point and one or more points of interest. In this regard, the electronic range finding device is operative to first determine a first distance between the device and the reference point and a second distance between the device and each point of interest (e.g., target). The device also includes a sensor that is operative to identify at least one angular orientation of the electronic range finding device relative to a predetermined frame of reference. Finally, the device includes a processor that is operatively interconnected to the electronic range finding device and the sensor and which is operative to utilize the first distance, the second distance and at least one angular orientation to calculate vector information between the reference point and the points of interest.

Various refinements exist of the features noted in relation to the subject first aspect of the present invention. Further features may also be incorporated in the subject first aspect of the present invention as well. These refinements and additional features may exist individually or in any combination. For instance, the reference point may be proximally located to the measurement device and in one arrangement be located an a vertical axis directly beneath the measurement device (e.g., a ground reference point). In any case, measuring the distance between the device and the reference points allows for determining a relative position of the device to the reference point. For instance, this distance may correspond to a height of the device above the ground. This may allow more accurate measurements to be made between the point of reference and the point of interest. That is, error associated with the position of the device may be reduced. In any case, vector information as well as the distance and/or angular orientation of a geophysical point of interest relative to the ground reference point may be stored. Furthermore, it will be appreciated that a plurality of geophysical points of interest may be measured and stored relative to a single ground reference point or a plurality of ground reference points for use in surveying and/or topographical map generation.

In one arrangement, the electronic range finding device includes a laser and a detector. The laser is operative to be controllably pulsed such that flight time of reflected light (i.e., from the geophysical point of reference) may be determined for distance calculation. In this regard, visible lasers and/or visible (e.g., IR) lasers may be utilized. The type of laser utilized may be selected for a particular purpose. The use of such lasers may be selected depending on distance requirements as well as light levels and wavelength of light

In another arrangement of the present aspect, the device includes a sighting device for use and identifying a point of interest. The sighting device may be utilized to, for example, aim the electronic range finding device at a particular point of interest. Such sighting devices may incorporate optical sights (e.g., telescopic devices), laser marking devices and/or a combination of the two. Where the sighting device comprises a marking laser, the visible laser may project a mark on the point of interest. As will be appreciated, when a visible laser is utilized for the electronic range finding device, that laser may form the marking laser. However, it will be appreciated that separate lasers may be utilized. Once sighted, the electronic range finding device may then generate distance information.

In another arrangement, the sighting device incorporates a digital camera that is operative to generate a digital image of the point of interest. In this regard, such a digital camera may incorporate an optical and/or digital magnification feature that allows the user to enhance the image of the point of interest such that the particular feature associated with that point of interest may be targeted for measurement. As will be appreciated, such targeting may incorporate the use of, for example, crosshairs generated on the digital image and/or the use of marking laser such that the mark generated by the laser on the point of interest is illustrated on the digital image. Accordingly, the measurement device may be adjusted (e.g., vertical or horizontal and/or azimuth or elevation) to position the electronic range finder on a desired feature. As will be appreciated, in some instances it may be desirable to store the digital image of the geophysical point of interest. In this regard, it will further be noted that distance, angular orientation, vector information and/or, if available, absolute location of the point of interest may be stored on or with the digital image.

In a further arrangement of the present aspect, the device may further incorporate a location determination device that is operative to determine the geodetic location of the measurement device. Such a location determination device may include software that allows the device to calculate (e.g., triangulate) its location based on the distance and angular orientation of two or more points having known (e.g., geodetic) positions. Alternatively, the location determination device may be a self-contained device, such as a GPS instrument, that is operative to determine its location relative to a predetermined frame of reference. In the case where the device is a GPS device, it will be appreciated that enhanced GPS units may be utilized including, for example, DGPS and RTK GPS.

The sensor is utilized to identify at least one angular orientation of the electronic range finding device relative to the predetermined frame of reference and may include first and second sensors that are operative to determine angular orientation relative to first and second axes, respectively. In this regard, a first sensor may incorporate a tilt meter operative to determine the angular orientation of the electronic range finding device relative to, for example, a horizontal plane of reference centered on the measurement device. The tilt meter may incorporate optical or MEMs based gyroscopic instruments. A second sensor may comprise a heading meter that is operative to determine, for example, azimuth information relative to a predetermined coordinate system. In this regard, such a heading meter may incorporate a compass that may include electronic and/or gyroscopic instruments. In any case, these sensors will be tied to processors such that, upon determining a measurement utilizing an electronic range finding device, the outputs of these sensors may be utilized for determining a relative location of a point of interest to the measurement device. Further, as noted above, the relative position may be converted to an absolute position. It will be further appreciated that the sensor may be operative to identify at least one angular orientation for each measurement (e.g., reference point and point of interest) of the electronic range finding device.

According to one particular arrangement of the present aspect, an electronic range finding device includes a first laser and a second laser for use in determining the first and second distances, respectively. In this arrangement, each laser may utilize a separate detector for use in determining light flight time and thus distance, or these lasers may share a common detector. The use of the first and second laser allows for the device to determine its height above the surface (i.e., ground reference point) as well as the distance to a point of interest. Such an arrangement may facilitate handheld use. In this arrangement, the sensor may be operative to provide angular orientation of each laser or may incorporate separate sensors for providing angular orientation of the separate lasers.

According to a second aspect of the present invention, a device is provided that allows for identifying a geophysical point of interest, generating a digital image of said point of interest and optionally projecting modeled data onto that digital image. As provided, the device includes a digital camera operative to generate a digital image of a point of interest. A display interconnected to the camera is operative to display the digital image while an electronic range finding device is operative to determine a distance and relative angular position between the device and the point of interest. As discussed in the first aspect of the invention, if the absolute location of the measurement device is known the absolute/geodetic location of the point of interest may be calculated. Accordingly, once the absolute location of the point of interest is determined, modeled data (e.g., design plan, plat map, etc.) may be electronically tied to the point of interest. Furthermore, such modeled data may be projected onto the digital image of the point of interest. In this regard, the user may be able to “see” the position of a future structure. For example, a wireframe model may be super-imposed over a real-time image that includes a targeting mark and referenced measurement data projected onto a current physical location. As will be appreciated, the digital image, distance, relative position, absolute position and/or modeled data projected onto the image may be stored for future use.

The digital camera may include an optical magnification and/or digital magnification feature to allow for providing an enhanced view of a point of interest. Once such an image is acquired, the user may position a target relative to the display such that the electronic range finding device is aimed at a corresponding position on the point of interest. This may entail, for example, moving crosshairs (e.g., through user interface) over the digital image to select a particular point on that image for distance and relative angular positioning. Alternatively, this may incorporate projecting a laser marker onto the geophysical point of reference such that a corresponding mark is provided on the digital image. What is important is that the digital image allows for a user to see a particular point of interest such that precise targeting of that point of interest may be achieved.

According to a further aspect of the present invention, a method for associating modeled data with geophysical locations is provided. The method includes identifying a reference point within a geophysical area. Based on the reference point, modeled data is associated with that geophysical area. For instance, once an absolute position of a reference point is know, modeled data may be tied to that reference point and/or oriented (e.g., relative to an azimuth reference) such that the modeled data is overlaid onto the geophysical area. Once so associated, a point of interest may be selected from the modeled data such that that point of interest may be located on the geophysical area. Accordingly, after the point of interest is selected, a visible mark is projected on the geophysical point within the geophysical area that corresponds to the point of interest from the modeled data. This point may be then marked. As will be appreciated, the present method facilitates layout of modeled data in the form of, for example, construction plans onto a geophysical location.

Identifying a reference point within a geophysical area may be accomplished in a number of different ways. For instance, the position of the reference point may be determined relative to one or more known geodetic points (e.g., survey markers). Alternatively, the position of the reference point may be determined utilizing location determination devices. For instance, the location of the reference point may be determined utilizing GPS information. As will be appreciated, different methods may be utilized based on the desired accuracy of the reference point.

Associating the modeled data to the geophysical area typically includes linking at least one point on the modeled data to the reference point and may further include linking numerous points on the modeled data to numerous points within the geophysical area. In this regard, additional reference points may be determined based on the relative positions to the initial point. For instance, utilizing a range finding laser and/or an angular orientation sensor, the relative locations of such reference points may be determined relative to the initial reference point. Accordingly, multiple geophysical points may be tied to multiple points on the modeled data.

The step of projecting a visible mark onto a geophysical point that corresponds with a point on the modeled data may be an automated process. Alternatively, such a process may be semi-automated wherein, a measurement device provides prompts to a user to locate the geophysical point. For instance, such a device may prompt a user to adjust azimuth and/or elevation settings such that marks (e.g., a visible laser) may be projected onto the geophysical point. In one embodiment, such a prompt may be provided to the user through a display device associated with such a measurement instrument.

In some instances, a point of interest from modeled data may be disposed below the current surface of a geophysical area. In this instance, the method may further include the step of projecting a mark onto the geophysical surface that, for example, is disposed on a vertical axis above/below the point of interest. For instance, if a point of interest from the modeled data lies 5 feet below the surface, the mark projected onto the surface may be located on a vertical axis above such point of interest and an output may be provided indicating that the projected mark is 5 feet above the actual point of interest. As will be appreciated, this may facilitate cut and fill procedures.

According to another aspect of the present invention, a method for creating a graphical representation of a geophysical area is provided. The method includes moving a range finding laser between a first and second position in a geophysical area, wherein the range finding laser is positioned at a reference position. While moving the laser between the first and second positions, a series of data inputs are acquired. The data inputs include a series of distances between the reference position and a series of projection positions of the laser on the geophysical area. The inputs further include a series of angular relationship between the reference position and the series of projection positions. Based on the data inputs, a series of vectors are generated between reference positions and the series of projection positions and/or between the projection positions. Utilizing such information, a rendering (e.g., wireframe) of the geophysical area may be provided. Further, post processing of the rendering may be performed. Such post processing includes smoothing, coloring, labeling, and material property enhancement.

The present aspect allows for the user to establish the position of a measurement device and sweep a range finding laser over the terrain in order to generate a topographical representation of that terrain (e.g., a topographical map). As will be appreciated, to provide adequate information for generating topographical information of a geographical area, the range finding laser may be moved between the first and second position in a raster type pattern to allow for information over an enhanced area to be incorporated into the resulting rendering. Furthermore, if the location of the reference point is known or becomes known, the actual location resulting graphical information can be tied to a predetermined coordinate system. That is, the absolute location of the graphical information may be established.

According to a further aspect of the present invention, a self leveling system for use with a measurement device is provided. As provided, the mounting system includes a ball joint assembly that allows the device to be self aligning relative to at least one axis (e.g., a vertical axis). For instance, in one embodiment, the mounting apparatus includes a tripod and the ball joint assembly. In this regard, the ball joint assembly allows a lower portion of the tripod to act as a pendulum. Accordingly, an instrument mounted to an upper portion of the tripod may be aligned with a vertical axis

Incorporated into the ball joint assembly is an optical imager that is operative to monitor the position of the joint and provide an output indicative thereof. Accordingly, when the joint is moved, the optical imager provides an output indicative of such movement. As will be appreciated, this movement may be associated with vertical, horizontal and/or rotationed positions such that the output of the optical imager may be utilized to provide angular orientation of the survey instrument or other measurement device disposed on top of the mounting apparatus.

### BRIEF DESCRIPTION OF THE DRAWINGS

FIG. 1 shows a first embodiment of the measurement device;

FIG. 2 shows an exploded view of the first embodiment of the device;

Fig. shows a ball joint assembly utilized with the embodiment of FIG. 1;

FIG. 4 shows a survey assembly of the first embodiment;

FIG. 5 shows an optics assembly of the survey assembly of FIG. 4;

FIG. 6 shows a ground positioning laser utilized with the embodiment of FIG. 1;

FIG. 7 shows hand held operation of the survey assembly of FIG. 4;

FIG. 8 shows a block diagram of the device;

FIG. 9 shows tri-pod operation of the survey assembly of FIG. 1;

FIG. 10 shows a vector storage array;

FIG. 11 shows a continuous scan methodology;

FIG. 12 shows an exemplary wire-frame generated by the device;

FIG. 13 shows one embodiment of a user interface for the device;

FIG. 14 shows modeled data that may be tied to physical measurements of the device;

FIG. 15 shows three dimensional object scanning;

FIG. 16 shows an embodiment of the device incorporated ground penetrating radar; and

FIG. 17 shows use complementary use of two of the measurement devices.

### DETAILED DESCRIPTION

The following description and figures illustrate one embodiment of a survey instrument that bridges the gap between physical properties of indoor and outdoor areas and seamlessly incorporates GIS information onto geophysical areas. As will be further discussed herein, the survey instrument utilizes advances in laser range finding, GPS systems (GPS), optical imagers, handheld computers and, optionally, ground penetrating radar to create an advanced function electronic survey instrument. The survey instrument is capable of remotely gathering relative positions of physical features such as structures, roads, trees, etc., and in one embodiment, subterranean features such as pipes, rocks, power lines, etc. The survey instrument calculates relative positions of the identified targets (i.e., to the survey instrument) through embedded processing of distances and angular feedback obtained from range finders and positioning sensors, respectfully, and stores the resulting array of data in memory. The instrument may then apply acquired GPS information or other known location information to the relative positions and associate the relative positions to a geodetic reference. That is, the relative positions may be converted to absolute positions. Once associated with the geodetic reference, the instrument may be utilized to project precise points onto a surveyed area wherein such points may be associated with modeled data (e.g., building plans).

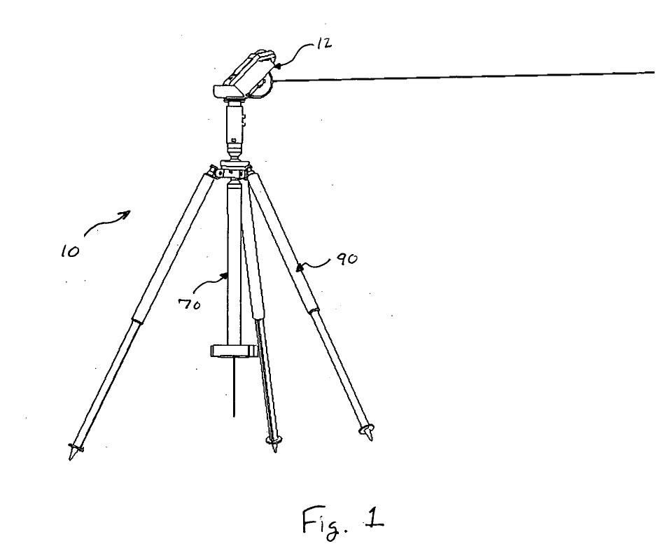

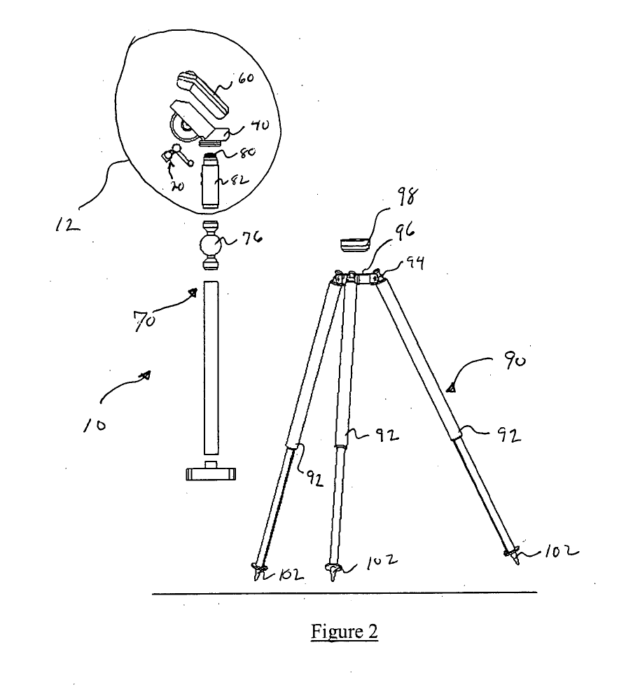

FIGS. 1 and 2 show a first embodiment of the survey instrument 10. As shown, the survey instrument 10 includes a survey assembly 12, a main body assembly 70 and a tripod assembly 90. The tripod assembly 90 and main body assembly 70 function as a vertical plumb indicator which eliminates the need for manually leveling the survey instrument 10. In this regard, the tripod assembly 90 includes three telescoping legs 92 which may be individually adjusted for varying terrain conditions. Each leg 92 further includes a removable foot 102 that may be selected depending on soil conditions. Furthermore, each leg 92 includes a quick-release lock 94 that, when depressed, locks the position of the leg 92 relative to a center socket 96 of the tripod assembly 90.

The center socket 96 is a ball socket that is sized to receive a spherical mounting ball 76 incorporated into the body of the main body assembly 70. Collectively the socket 96 and mounting ball 76 define a ball joint assembly. When the mounting ball 76 is disposed within the socket 96 the main body assembly 70 is operative to function as a vertical plumb indicator and thereby provide two axis of vertical symmetry for the survey assembly 12. The main body assembly 70 further includes a lower pendulum section 72 (i.e., beneath the mounting ball 76) that provides the weight that allows the main body assembly to operate as a vertical plumb indicator. In this regard, the pendulum section 72 may house batteries or other heavy components for the survey instrument 10. The tripod assembly 90 further includes a locking ring 98 that is operative to selectively clamp the mounting ball 76 relative to the socket 96 once the main body assembly has achieved two axis of vertical alignment (i.e., a plumb position).

Releasably interconnected to the mounting ball 76 on the main body assembly 70 is a control handle 82 of the survey assembly 12. Control handle 82 allows a user to selectively move the main body assembly 70 from a plumb position for marking offsets and/or to perform continuous scanning operations, as will be discussed herein. Furthermore, control handle 82 may include one or more control buttons 84 that may be operatively connected to the survey assembly 12 to control one or more instrument functions. Finally, on the bottom of the main body assembly there is an electronics housing 74 that may be utilized to house an offset laser and/or ground penetrating radar, as will be more fully discussed herein.

As shown in FIG. 3, the present embodiment of the survey instrument 10 further includes a position encoder for the ball joint assembly. That is, the socket 96 of the tripod assembly 90 further includes an optical imager 100 for optically monitoring the surface of the mounting ball 76. In this regard, the optical imager 100 is operative to monitor the movement of the mounting ball 76 and generate an angular displacement associated with that movement. The angular displacement may be tied to position imaging lasers of the survey device 10, as will be discussed herein. Accordingly, the optical imager 100 may be electrically connected (e.g., wired) to the main body assembly 70.

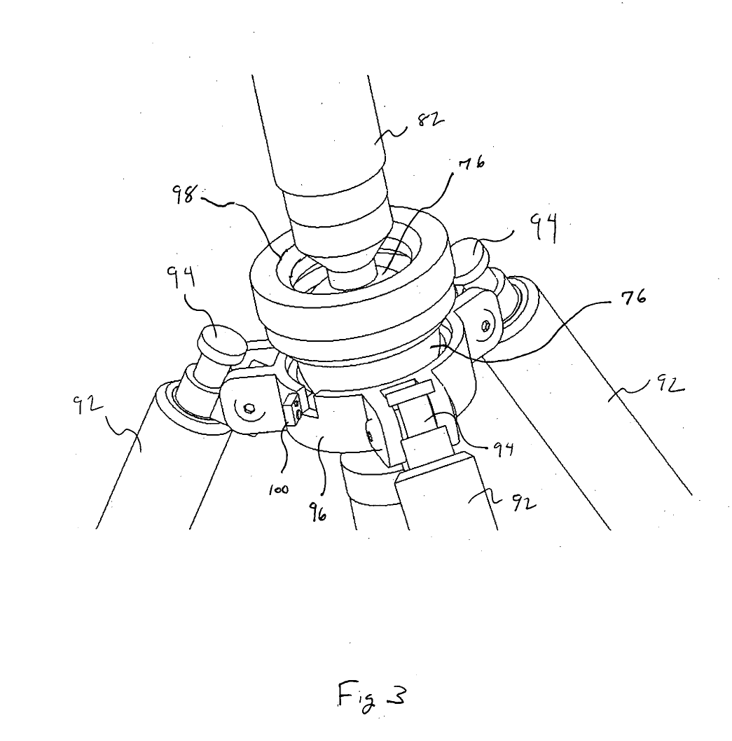

FIGS. 2 and 4 show one embodiment of the survey assembly 12. As shown, the top of the assembly 12 includes an azimuth gear 80 disposed between the top of the control handle 82 and the bottom of a cradle assembly 40 to which various components are mounted. Accordingly, the cradle assembly 40 includes a gear socket on its bottom surface (not shown) that is sized to receive the azimuth gear 80 as well as a horizontal adjustment knob 44 for use in turning the cradle assembly 40 relative to the azimuth gear 80. In this regard, the horizontal adjustment knob 44 may be attached to an idler gear (not shown). Further, one or more sensors may be attached to the gears 80 and/or knob 44 to detect movement of the cradle assembly 40 in the horizontal plane (e.g., azimuth movement). In addition, the top end of the control handle 82 may further include one or more electrical connectors that may be received within mating electrical connectors (not shown) within the cradle 50. As will be appreciated, this allows for communication between, for example, the survey assembly 12, batteries, the optical imager 100 and/or electronics disposed within the pendulum section 74.

The cradle assembly 40 includes a recessed top surface that is operative to receive a handheld computer 60 therein. Furthermore, electrical connectors may be disposed within the recessed top surface 42 for electrically interconnecting the handheld computer 60 to an optics assembly 20 and/or other electronics assemblies within the survey instrument 10. Finally, the cradle assembly 40 includes a circular race 46 that allows for pivotal movement of the optics assembly 20 about a pivot point 48. In this regard, the optics assembly 20 is pivotally interconnected to the cradle assembly 40 about the pivot point 48.

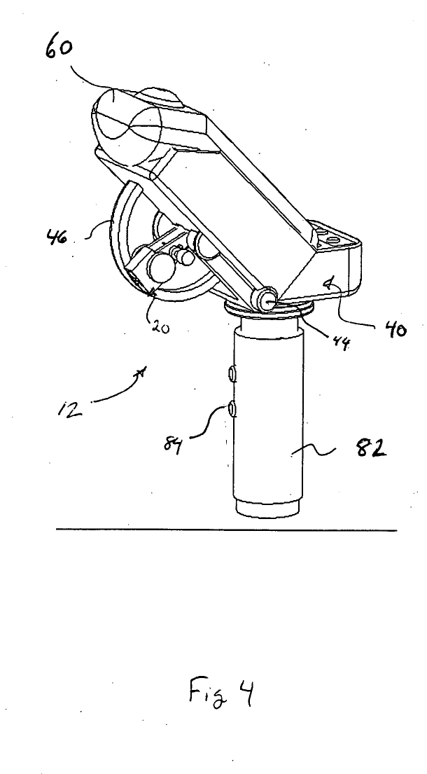

Referring to FIG. 5, the optics assembly 20 is more fully shown. The optics assembly 20 includes an elevation gantry assembly that includes first and second gears 26A, 26B. The elevation gantry assembly is utilized for adjusting the elevation angle (e.g., relative to a horizontal plane) of the optics assembly 20. As shown, the first gear 26A is interconnected to a vertical adjustment knob 24. When the vertical adjustment knob is rotated (e.g., by a user) the first gear 26A rotates the second gear 26B. The second gear 26B is interconnected to a mating gear 26B by an axle (not shown). An outside surface of the second gear 26B rides on an inside surface of the generally circular race 46. Accordingly, by turning the vertical adjustment knob 24 the optics assembly 20 may be rotated about the pivot 48. Accordingly, one or more sensors may be attached to the gantry assembly or the vertical adjustment knob 24 to determine elevation information.

In the embodiment shown, the optical assembly 20 includes a digital camera 28 for use in providing electronic images (i.e., a digital picture) for sighting purposes. That is, instead of utilizing an optical lens that is typical in most theodolites, the survey instrument 10 utilizes digital images for sighting purposes, which may allow for digital magnification (i.e., zooming) and/or storing acquired images. However, it will be appreciated that combined digital cameras and/or optical lens may also be utilized for sighting purposes. The optics assembly 20 also includes a range finding laser 30 (e.g., an infrared laser) and a marking laser 32 (e.g., a visible laser). The marking laser 32 is utilized for projecting a sighting mark onto a desired target. In this regard, the digital camera 28 provides an image that shows the location of the sighting mark as projected onto a target. This allows positioning the marking laser 32 on a desired target for measurement purposes using, for example the vertical adjustment knob 24 and/or the horizontal adjustment knob 44.

The range finding laser 30 may then be pulsed to determine a distance between the instrument 10 and the target (i.e., sighting mark). In this regard, the optical assembly 20 also includes a receiver 34 for receiving laser light reflected from the target. The distance between the survey instrument 10 and the targeted position may be established by the receipt of a reflected pulse from the target. Preferably, the reflected light will be light reflected from the surface of the target object as opposed to light reflected from an object placed on the target. In this regard, the need for a second person for target positioning, e.g., positioning a range finding pole at the target, is eliminated. That is, the present survey instrument 10 allows for single person operation.

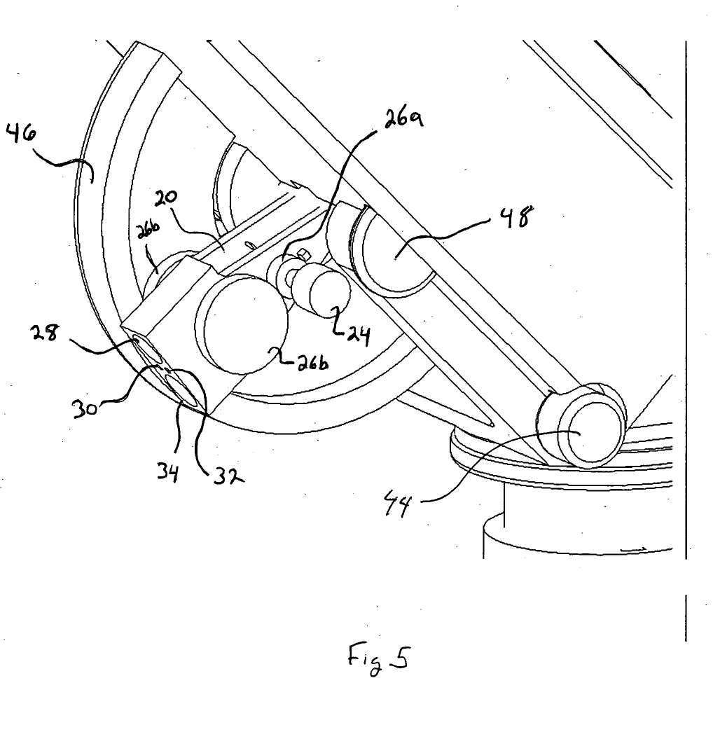

For measurement purposes, the position (e.g., height) of the survey assembly 12 above the ground and/or relative to a reference point may also be required. In this regard, the instrument 10 utilizes a laser to determine survey assembly height and/or offset. FIG. 6 shows one embodiment where an offset laser 78 is incorporated into the electronic housing 74 of the pendulum 72. The offset laser 78 allows for the survey instrument 10 to be located near a known survey point (e.g., a geodetic point) without necessarily having to be located in a vertical position directly above the known point. In this regard, the tripod assembly 90 may be set up to allow the main body assembly 70 to obtain a plumb position. The user may then activate the offset laser 78 (e.g., utilizing one of the control handle buttons 84). The offset laser 78 may then be moved to illuminate the known survey point (e.g., disposed within a movement range of the main body assembly 70). Once the offset laser 78 is positioned on the known survey point, a second button may be depressed that may, for example, pulse the offset laser to measure distance between the survey instrument 10 and the known survey point. Furthermore, the optical imager 100 may provide angular offset information (e.g., azimuth and/or elevation information) such that the relative position of the survey instrument 10 to the geodetic point may be determined. In any case, utilization of the offset laser 78 reduces the time necessary to provide exact vertical positioning above such known survey points.

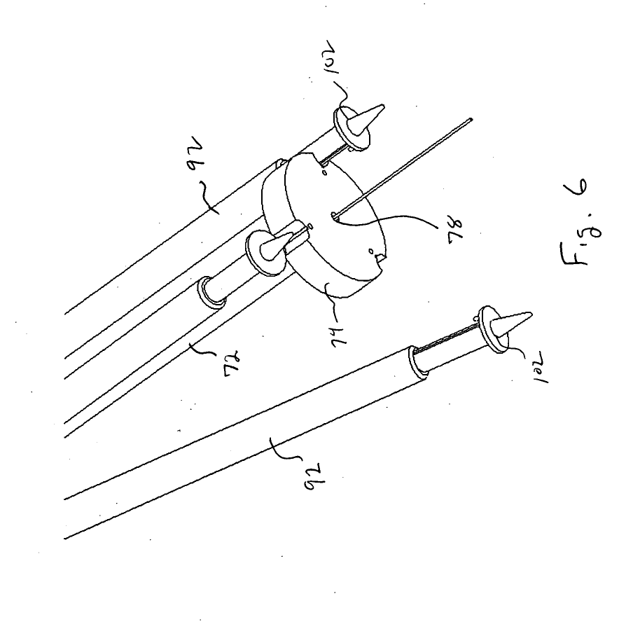

FIG. 7 shows another embodiment where a range finding laser is utilized to determine the height of the survey instrument 12 relative to the ground. As shown in FIG. 7, the survey instrument 12 has been removed from the mounting ball 76 for handheld operation. In this regard, a range finding laser is projected through the bottom of the handle 82 to determine a first distance h to reference point r on the ground. As will be appreciated, this first distance h may be utilized in conjunction with a second distance d between the survey assembly 12 and a target point t in order to calculate distance and/or direction v between the reference point r and the target point t, as will be more fully discussed herein. As will be appreciated, when utilized as a handheld instrument, the survey instrument 12 may utilize a separate laser for height determination or, through the use of optics, utilize the same range finding laser 30 for height and/or offset determination, as discussed above in relation to the tripod assembly.

To facilitate measurement as a hand held instrument, the survey instrument 10 may incorporate heading meters (e.g., compass) and/or a tilt meters as well as other location determining devices (e.g., GPS) such that the position/orientation of the survey instrument 10 may also be known relative to one or more references (e.g., geodetic points, horizontal etc.). Though use of a location determining device such as GPS may be used to establish an absolute location of the instrument, it will be appreciated that the absolute position of the survey instrument may also be determined by identifying its location relative to two or more geodetic points. That is, by locating two known points, he position of the instrument 10 may be calculated (e.g., through triangulation).

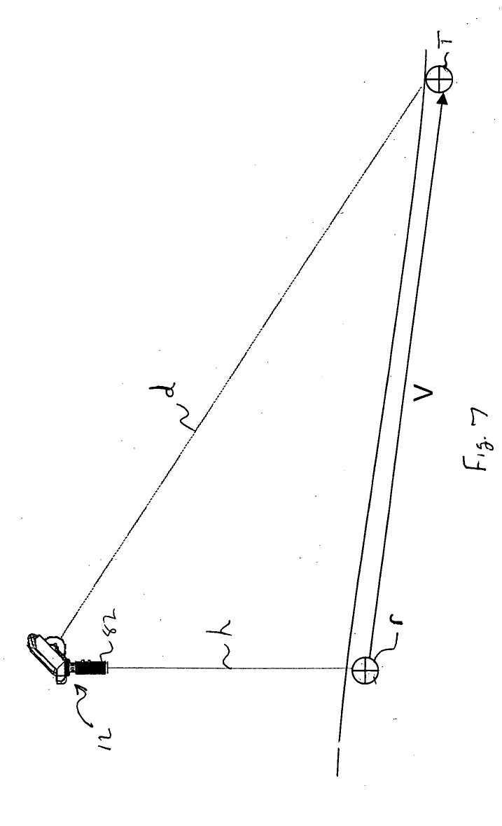

FIG. 8 shows a block diagram of the survey instrument 12. As shown, the survey instrument 12 includes a system controller/vector processor 60 that is operative to receive information from the various system components. These components include the first and second lasers 30, 32 as well as the distance meter 66 interconnected to the lasers 30, 32. As will be appreciated, the distance meter 66 may be operatively interconnected to the receiver 34 associated with the laser 30, 32 in order to determine distance. In this regard, the distance meter 66 is operative to determine the flight time of light reflected back to the receiver 34. Further, it will be noted that distance meter 66 may be operatively interconnected to both lasers 30, 32 such that each laser 30, 32, including a visible laser, may be utilized for range finding purposes. Also interconnected to the system controller 60 are an x-axis encoder 36 and a y-axis encoder 38. These encoders, 36, 38 may be operatively interconnected to the horizontal adjustment knob 44 and the vertical adjustment knob 24 in order to provide, for example, azimuth and elevation information. Likewise, the optical imager 100 associated with the ball joint assembly is interconnected to the system controller 60 to provide two axis positioning information, as will be more fully discussed herein.

The system controller 60 is also operative to receive heading information from a header meter 62 that may incorporate a compass and/or gyroscopic components. A Tilt meter 64 provides information relative to tilt of the assembly 12 relative to, for example, a horizontal plane centered at the instrument 10. The system controller 60 is also operatively interconnected to a handheld computer 120 that includes a display screen 124 on which information may be provided. As may be appreciated, the handheld computer 120 may incorporate software utilized for linking modeled data (e.g., plat maps, design plans etc) with a geophysical area, as will be discussed herein. Furthermore, the handheld computer 120 is operatively interconnected to the digital camera 28 such that additional images from the camera 28 may be displayed on the computer display 124. Finally, the handheld computer also incorporates a GPS module 122 such that the location of the survey instrument 12 may be determined without reference to known geodetic points.

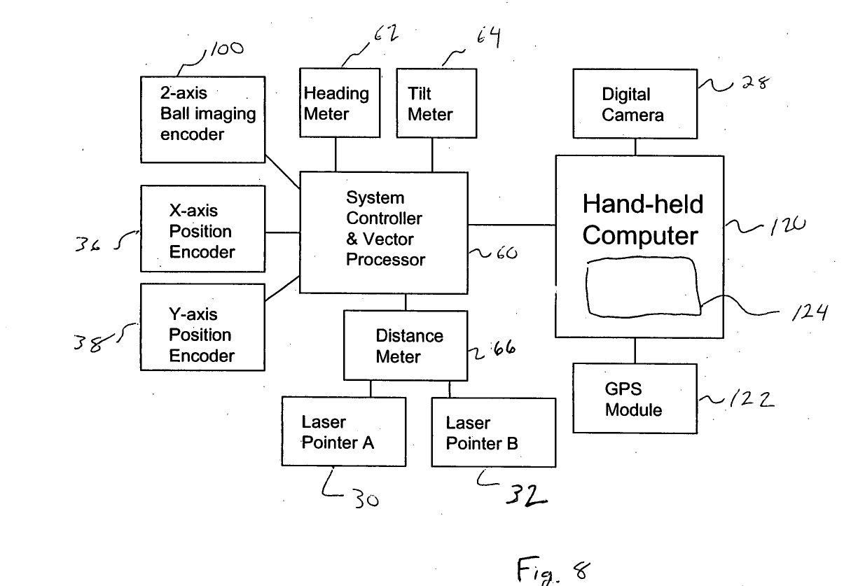

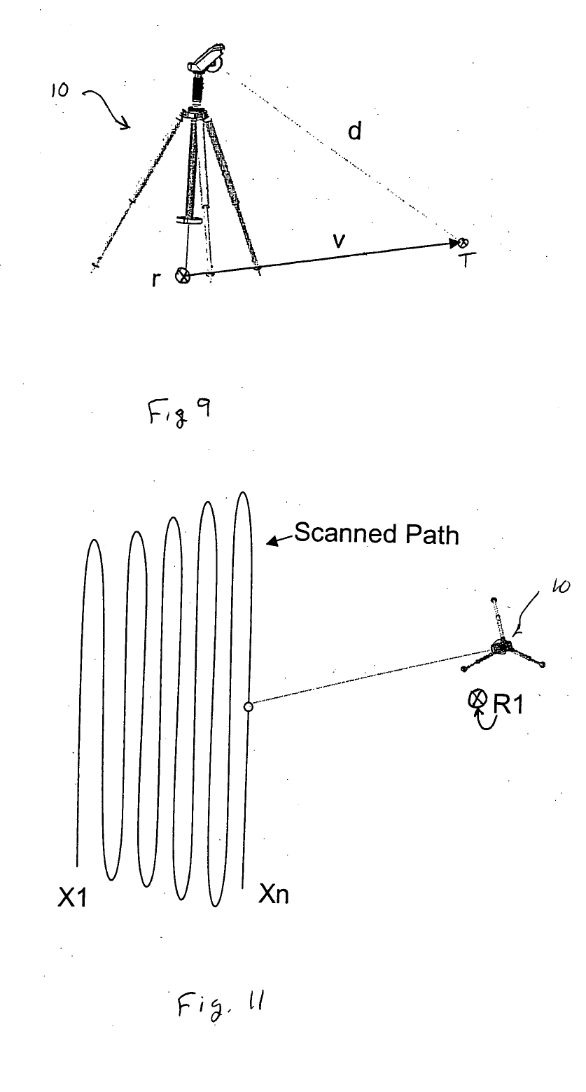

Referring to FIGS. 7, 9 and 10, the use of the survey instrument 10 for surveying purposes is shown. As will be appreciated, for surveying, three things must be measured: elevation, azimuth and distance. Accordingly, by measuring the elevation, azimuth and distance d of a target a relative position of that target t to the survey instrument 10 may be determined. More particularly, a vector v representing specific measurements between a number of reference points r and targets t may be calculated. Furthermore, if the geodetic location of the survey instrument 10 is known, an absolute location of the survey point may be determined.

The present survey instrument 10 utilizes an onboard memory that allows for acquisition and storage of a plurality of survey points. These survey points, obtained as relative positions to the survey instrument 10, may be later converted to absolute locations by correlating the relative positions to one or more absolute locations as determined by, for example, locating known geodetic points and/or utilization of GPS coordinates. In determining each survey point, the instrument 10 determines a vector v from a given reference point r (i.e., location of the survey instrument 10) to a given target point t. Specifically, the survey instrument 10 measures the distance d to the target t utilizing the range finding laser 30. The instrument also records the elevation angle and azimuth angle by reading the position encoders 36, 38 connected to the vertical adjustment knob 24 and horizontal adjustment knob 44 when utilized with the tripod assembly 90 Alternatively, the loading meter 62 and tilt meter 64 may be utilized during handheld operation. The height h between the ground and the optics assembly 20 of the instrument 10 can be determined, using a second laser range finder, such that the precise-length and direction of the vector v between the reference point r and the target t may be obtained. Accordingly, multiple vectors can be extrapolated to create wireframe models which can then be used to create topographical maps. The raw data may also be post-processed and rendered to create virtual map of the scanned area.

Multiple vectors v may be acquired and stored in memory (e.g., in one or more arrays) for further processing. In this regard, the vectors may initially be stored as relative positions to the reference point(s) r for later conversion to the absolute positions. In one embodiment, this may allow for surveying indoors and/or underground where no geodetic points are available. In this regard, upon completing a survey of such an area the instrument 10 may project a point utilizing the visible laser 32 to a position where a geodetic point may be viewed. Once the visible laser projects a point to such a location, the point may be marked. Accordingly, the survey instrument 10 may be moved to the marked position. This movement is recorded for later use in generating absolute location information. This process may be repeated several times if necessary (e.g., to move the instrument outside). Once the survey instrument 10 is located in a position where a geodetic point may be identified (e.g., utilizing the range finder/visible laser and/or GPS capabilities) the stored vector array may be converted to absolute known positions relative to the geodetic point(s). As may be appreciated, when utilizing GPS information the use of a single point may result in a higher uncertainty than utilization of two or more GPS locations. Accordingly, the survey instrument may be moved one or more times in accordance with the process outlined above such that multiple GPS locations may be determined to reduce the error associated with the measured data.

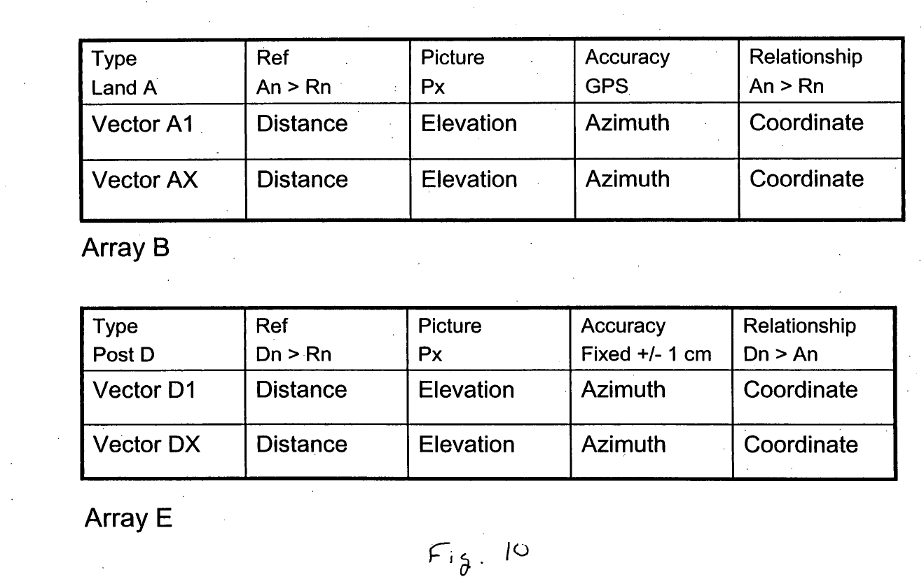

In addition to general surveying applications, the survey instrument 10 also provides a continuous scan acquisition mode. As shown on FIG. 11, the continuous scan acquisition mode allows the survey instrument 10 and, in particular, the range finding laser 30 to be moved in a continuous motion over a given terrain. During motion of the range finding laser 30 over a scan path between xl and xn, a plurality of vectors are generated. The rate at which these vectors are taken may be adjusted for a given requirement. Typically, at least about 30 vectors are taken per second. In any case, as the range finding laser 30 is moved over the scan path between xl and xn, an array of vectors are created.

As will be appreciated, the horizontal and vertical adjustment knobs 24, 44 do not provide movement necessary to permit rapid scanning for the continuous acquisition mode. Therefore, rather than using the fine adjustment provided by the knobs 34, 44, the ball joint 76 is utilized to move the laser 30. That is, the lock of the tripod assembly 90 is moved to an unlocked position such that the ball joint 76 may be freely moved. Accordingly, a user may use the control handle 82 to manually move the infrared laser 30 over an area for scanning purposes. As will be appreciated, the visible laser 32 may be activated during this scanning process such that a user may track its movement over the terrain. In this continuous acquisition mode, the elevation and azimuth information required to generate each of the vectors is provided by the optical imager 100 associated with the ball joint assembly. That is, the angular position of the range finding laser 32 is determined from the mounting ball 76 orientation, utilizing distance information from the infrared laser and the angular position associated with the laser, vectors are calculated and stored. This continuous acquisition mode allows an operator to sweep a laser across a terrain to create a three-dimensional topographical map.

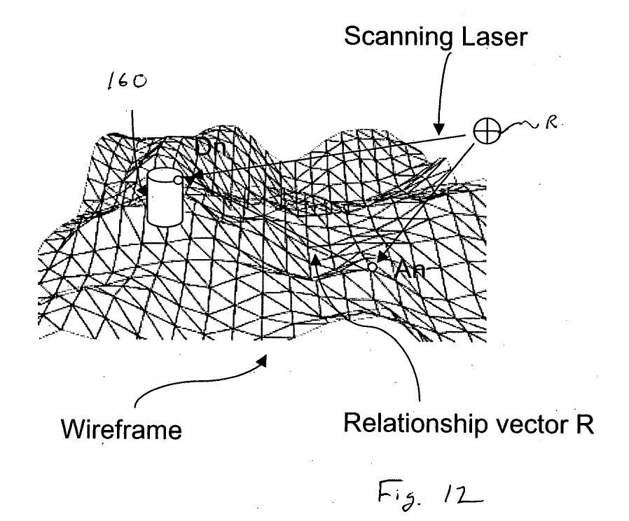

The survey instrument 10 may utilize a data link (e.g., wireless link) to transfer data to a remote data storage device and/or a processor (e.g., computer) for remote data processing/rendering. Such a computer may also be interconnected to network information such as the internet. In this regard, a two way communication channel may exist such that data (e.g., GIS information) may be provided to the survey instrument 10. As will be appreciated, to provide enough processing and data storage capability for continuous acquisition scanning, the data link may have to be active during scanning: In any case, a vector array from the scanning process may be uploaded to the remote processor. Post-processing of the vectors may generate a wireframe as shown in FIG. 12. Such a wireframe may then be rendered to provide a topographical relief map of an area. Furthermore, utilization of the digital camera 28 may allow for shading and/or coloring of the rendered topographical map in accordance with physical attributes of the scanned area.

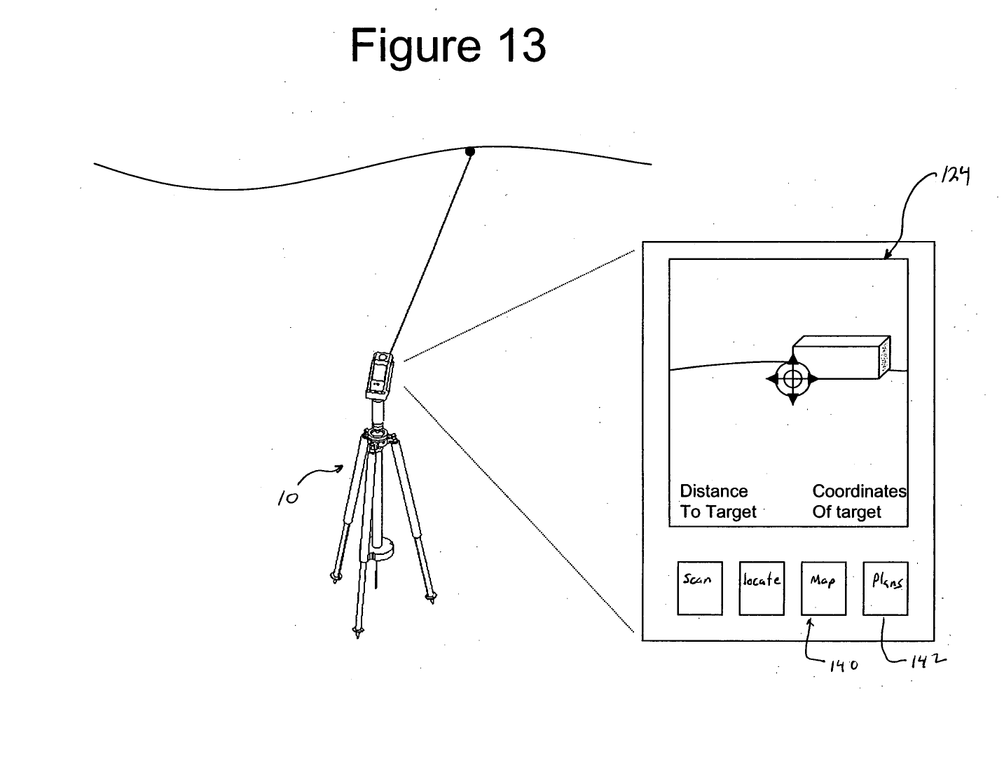

The survey instrument 10 may also provide a locate mode wherein the instrument 10 can be utilized to tie maps, design plans and/or other model data to geophysical positions. As shown on FIG. 13, the user display 124 may provide for one or more modeled data options. For instance, a user may be able to select a plat map 140 and/or design plans 142 associated with a geophysical location of interest. Once such modeled data are selected, they may be displayed on the user display. The user may then select individual points on those plans (e.g., using a touch screen control or via data entry) that the user wishes to locate relative to the geophysical location. In this regard, once the location of the survey instrument 10 is known relative to its current geophysical location, the survey instrument 10 may be operative to identify points on model data associated with that geophysical location.

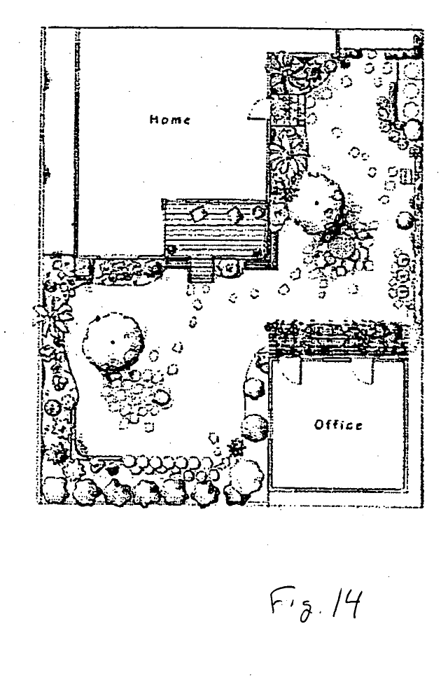

For instance, as shown on FIG. 14, a user may be interested in locating a corner point of the home shown in modeled design plans. By selecting the corner point on the model data, the user may then prompted to move the optical assembly 20 such that the marking laser 32 projects a mark onto the geophysical location associated with the selected corner point. For instance, if the optical assembly 20 needs to be turned 90° an arrow may be provided on the display 124 indicating that the assembly 12 needs to be turned. Likewise, up and down arrows may be provided for elevation adjustments. Furthermore, it will be appreciated that such functionality may be automated using, for example, servo motors. Accordingly, when such a mark is projected onto the geophysical location, the mark may be staked. In this regard, the user may rapidly layout, for example, construction plans.

As may be appreciated, in some instances the location of points from modeled data may lay below the current surface of a geophysical location. In this regard, where cuts are required (e.g., for foundations, etc.) the instrument 10 may be operative for providing location marks that are vertically oriented above the desired geophysical location and/or providing information regarding the depth of the desired geophysical location beneath the surface.

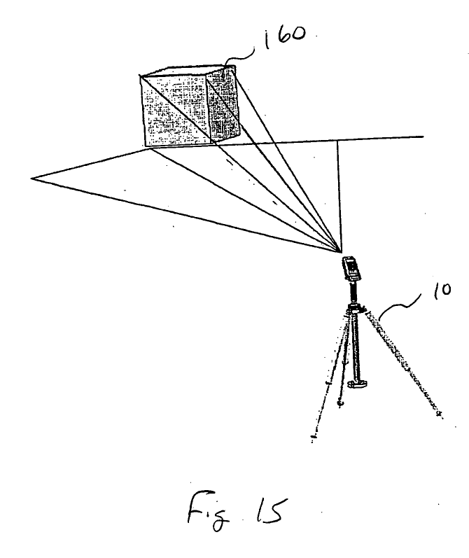

According to a further method, the survey instrument 10 may have the ability to scan structures to create three-dimensional models of those structures. For instance, as shown in FIG. 15, a user may scan physical objects to create a three-dimensional model. Such scanning may be done in the continuous acquisition mode described above and/or utilizing single point scanning more typically associated with surveying. Once such a three-dimensional model is created, it may be projected onto a digital image associated with the display. For instance, the model structure 160 may be projected onto a digital photo of a geophysical location. Furthermore, the structure may be tied to GIS information such that, for example, a corner of the structure 160 is located at a desired geophysical location.

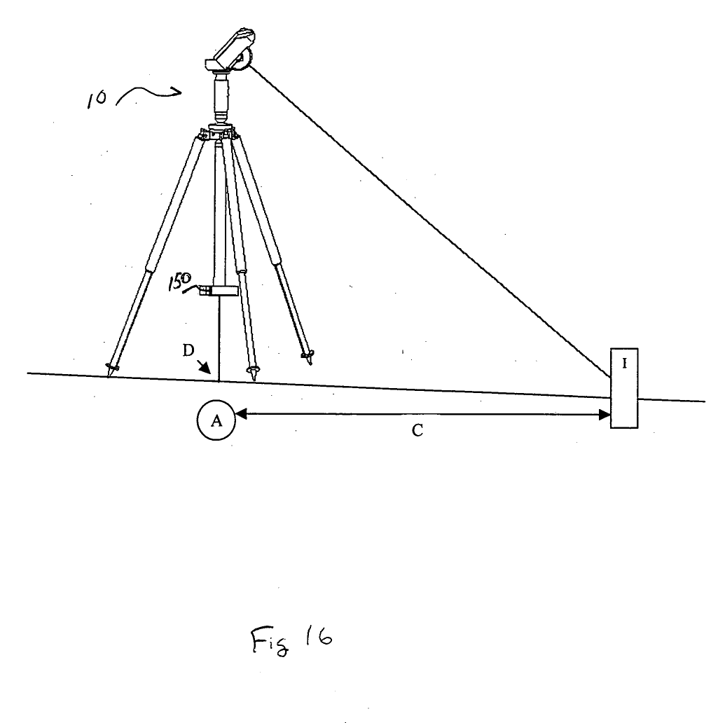

FIG. 16 illustrates another embodiment of the survey instrument 10. In this embodiment, the survey instrument 10 further includes a ground penetrating radar 150 disposed in the electronics housing 74 of the main body assembly 70. Such ground penetrating radar may be added to the main body assembly 70 to allow the instrument 10 to locate buried utility lines and/or other underground structures. In accordance with the methods described above, the absolute location of the underground structures may be tied to GIS data and/or to model data for construction purposes.

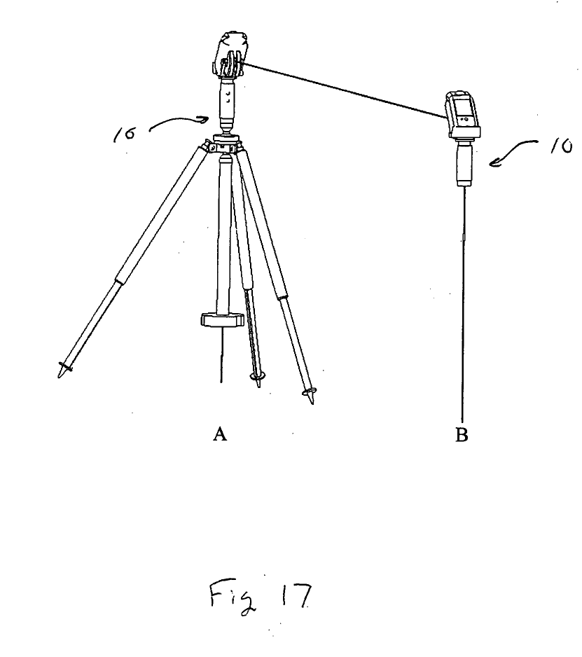

FIG. 17 illustrates an additional use of the survey instrument 10. In particular, two survey instruments 10 are interconnected by a wireless link. In this regard, the instruments may be linked using one or both of their lasers. That is, the lasers may be directed toward one another and modulated such that data can be passed back and forth over long distances. As will be appreciated, magnified digital camera images as seen on the display may be utilized to align the units. This arrangement may allow for the first unit, for example unit A, to remain at a known location and act as a reference for a second unit at a location where the second unit may not be able to receive, for example, GPS reception.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A measurement device, comprising:
an electronic range finding device operative to determine:
a first distance between said device and a ground reference point;
a second distance between said device and a geophysical point of interest;
a sensor operative to identify at least one angular orientation of said electronic range finding device relative to a predetermined frame of reference; and
a processor operatively interconnected to said electronic range finding device and said sensor, said processor being operative to utilize said first distance, said second distance and said at least one angular orientation to calculate vector information between said ground reference point and said geophysical point of interest.

2. The device of claim 1, wherein said electronic range finding device comprises a laser and a detector.

3. The device of claim 2, wherein said laser is a visible laser.

4. The device of claim 2, wherein said laser is an infrared laser.

5. The device of claim 1, further comprising:
a sighting device for use in identifying said geophysical point of reference.

6. The device of claim 5, wherein said sighting device comprises a marking laser operative to project a visible mark onto said geophysical point of reference.

7. The device of claim 5, wherein said sighting device comprises a digital camera operative to generate a digital image of said geophysical point of reference.

8. The device of claim 7, wherein said digital camera further includes at least one of:
an optical magnification feature; and
a digital magnification feature.

9. The device of claim 7, wherein said processor is operative to superimpose modeled data onto said digital image.

10. The device of claim 1, further comprising:
a memory for storing at least said vector information.

11. The device of claim 10, wherein said memory is operative to store an array of vectors associated with a plurality of geophysical points of interest.

12. The device of claim 11, wherein said processor is operative to utilize said array of vectors to generate a topological rendering of a geophysical area including said plurality of geophysical points of interest.

13. The device of claim 1, wherein said processor is operative to utilize said vector information to generate geodetic location information for said geophysical point of interest.

14. The device of claim 13, wherein said device further comprises:
a location determination device operative to determine the geodetic location of said device.

15. The device of claim 14, wherein said location determination device comprises a GPS device.

16. The device of claim 1, wherein said electronic range finding device comprises a first laser, a second laser and at least one detector.

17. The device of claim 16, wherein said first laser is operative to determine said first distance and said second laser is operative to determine said second distance.

18. The device of claim 17, wherein said sensor is operative to identify at least one angular orientation for each of said first and second lasers.

19. The device of claim 18, wherein said processor is operative to utilize said first distance and said at least one angular orientation for said first laser to determine a height of said device above said ground reference point.

20. The device of claim 1, wherein said sensor is operative to provide two axis of angular orientation information.

21. The device of claim 20, wherein said sensor is operative to provide azimuth and elevation information.

22. The device of claim 20, wherein said sensor comprises a first sensor associated with a first axis and a second sensor associated with a second axis.

23. The device of claim 22, wherein said first sensor comprises a tilt meter and said second sensor comprises a heading meter.

24. The device of claim 1, further comprising:
a self leveling tripod assembly for supporting said device.

25. The device of claim 24, wherein said self leveling tripod includes a ball joint assembly.

26. The device of claim 25, further comprising:
an optical imager for monitoring a position of a mounting ball of said ball joint assembly, said optical imager being further operative to generate an output corresponding to said position.

27. The device of claim 26, wherein said output of said optical imager is indicative of the angular orientation of said electronic range finding device relative to a predetermined frame of reference.

28. The device of claim 1, further comprising:
a data link for exchanging data.

29. The device of claim 28, wherein said data link is a wireless data link.

30. A measurement device, comprising:
a digital camera operative to generate a digital image of a point of interest;
a display operatively interconnected to said digital camera, said display being operative to display said digital image; and
an electronic range finding device operative to determine a distance and a relative angular position between said device and said point of interest.

31. The device of claim 30, wherein said electronic range finding device comprises:
a laser;
a detector; and
a sensor operative to identify at least one angular orientation of a projection path of said laser relative to a predetermined frame of reference.

32. The device of claim 31, further comprising:
a processor operatively interconnected to said laser, said detector and said sensor, said processor being operative to utilize said distance and said at least one angular orientation to calculate vector information between said device and said point of interest.

33. The device of claim 32, wherein said processor is operative to superimpose data onto said digital image.

34. The device of claim 33, wherein said data comprises modeled data.

35. The device of claim 34, wherein said processor is operative to link a reference point within said modeled data to said point of interest.

36. The device of claim 30, further comprising:
a memory for storing at least one of said distance, said relative angular position and said digital image.

37. The device of claim 36, wherein said memory is operative to store an array of distances and relative angular positions associated with a plurality of points of interest.

38. The device of claim 30, wherein said device is operative to utilize said distance and relative angular position to generate geodetic location information for said point of interest.

39. The device of claim 30, wherein said digital camera includes at least one of:
an optical magnification feature; and
a digital magnification feature.

40. The device of claim 30, further comprising:
a sighting device for use in identifying said geophysical point of reference.

41. The device of claim 40, wherein said sighting device comprises a marking laser operative to project a visible mark onto said geophysical point of reference.

42. A method for associating modeled data with geophysical locations, comprising:
identifying a reference point within a geophysical area;
based on said reference point, associating modeled data with said geophysical area;
selecting a point of interest from said modeled data; and
projecting a visible mark onto a geophysical point within said geophysical area that corresponds to said point of interest.

43. The method of claim 42, wherein said identifying step comprises:
determining a relative position of said reference point to at least one known geodetic point of reference.

44. The method of claim 42, wherein said identifying step comprises determining the geodetic location of said reference point utilizing a location determination device.

45. The method of claim 42, wherein said identifying step comprises determining the GPS location of said reference point.

46. The method of claim 42, wherein said associating step comprises linking at least a first point of said modeled data to said reference point.

47. The method of claim 42, wherein said projecting said visible mark step further comprises:
repositioning a projection device such that said visible mark may be projected on said point.

48. The method of claim 47, further comprising:
providing a user prompt for use in repositioning said device.

49. The method of claim 42, further comprising:
providing information relating to the location of said geophysical point relative to the surface of said geophysical area.

50. A method for creating graphical representations of a geophysical area, comprising:
moving a range finding laser between first and second positions in a geophysical area, wherein said range finding laser is positioned at a reference position; and
acquiring a series of data inputs as said range finding laser moves between said first and second positions, wherein said series of data input includes:
a series of distances between said reference position and a series of projection positions of said laser on said geophysical area; and
a series of angular relationships of said series of projection positions relative to said reference position;

51. The method of claim 50, further comprising:
based on said data inputs generating a series of vectors between at least one of:
said reference position and said projection positions; and
at least two projection positions.

52. The method of claim 51, further comprising:
generating a rendering of said geophysical area based on said series of vectors.

53. A measurement device, comprising:
a first electronic range finding device operative to determine at least a vertical distance between said device and a ground reference point;
a second electronic range finding device operative to determine a second distance between said device and a geophysical point of interest;
a sensor operative to identify first and second angular orientations of said first and second electronic range finding devices, respectively, relative to a predetermined frame of reference; and
a processor operatively interconnected to said first and second electronic range finding devices and said sensor, said processor being operative to utilize said first distance, said second distance and said first and second angular orientations to calculate vector information between said ground reference point and said geophysical point of interest.
